(19) United States
(12) Patent Application Publication
(10) Pub. No.: US 2004/0252747 A1
(43) Pub. Date: Dec. 16, 2004

(54) In-process verification system

(76) Inventors: Leland Garvelink, Holland, MI (US); James E. White, Muskegon, MI (US); Mark Kemple, Kalamazoo, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/865,277

(22) Filed: Jun. 10, 2004

Related U.S. Application Data
(60) Provisional application No. 60/478,020, filed on Jun. 12, 2003.

(51) Int. Cl. G01K 1/16; G01J 5/00

(52) U.S. Cl. 374/121; 374/141

(57) ABSTRACT

An in-process verification system includes a base and a support. The base includes a holding location for holding and locating a sample of a material. The system also includes an infrared sensing system with a sensor head supported by the support above the base in spaced vertical registry with the base and aligned over the holding location. The infrared sensing system measures the infrared radiation emitted by the material and calculates the temperature of the material.

This application claims priority from U.S. provisional application Ser. No. 60/478,020, filed Jun. 12, 2003, entitled IN-PROCESS VERIFICATION SYSTEM, by Applicants Leland Garvelink, James E. White, and Mark Kemple, which is incorporated by reference herein in its entirety.

The present invention generally relates to an in-process verification system and, more particularly, to a method and apparatus for verifying and documenting whether a material has been heated to a desired temperature.

Thermoplastic and thermo-set plastic adhesives are commonly used in the assembly of a wide variety of components, such as vehicle components. The adhesives are typically dispensed from a melter system through a hand-held gun. Melter systems include a heated holding tank and a hose that delivers the melted adhesive to the gun for application. However, on occasion it has been found that adhesives dispensed from melter systems may not be adequately heated, for example, because the heater is out of calibration or due to the heat losses that occur in the hose.

While there are many factors that effect the stability of the adhesive—such as, the method of application, i.e. sprayed, extruded, or nitrogen fused; the amount of adhesive; the open time (the time between application of adhesive and combining the parts to be assembled); and the compression time (the time the two parts are held together to allow the adhesive to cool and set)—one of the most important factors is the temperature of the adhesive. If a thermoplastic/thermo-set plastic adhesive is not properly heated to its heat application temperature, the adhesive will not be properly activated and will not meet its expected performance standards.

Conventional methods of temperature verification fall into two categories: invasive methods and non-invasive methods. For example, non-invasive methods include the use of hand-held infrared (IR) guns that measure the temperature of the heated and applied adhesive. However, the accuracy of the temperature readings are affected by the distance of the gun from the part to which the adhesive has been applied and the angle at which the gun is oriented when measuring the temperature. Furthermore, the temperature reading may be affected by the temperature of the part or parts to which the adhesive is applied. For example, if the gun is not accurately focused on the adhesive, the gun may measure the temperature of the part in addition to or instead of the adhesive temperature.

Invasive techniques directly measure the temperature of the adhesive by contacting the adhesive with, for example, a thermocouple or pyrometer. However, these invasive techniques do not lend themselves to repetitive situations and, further, are typically not instantaneous. As would be understood, therefore, the accuracy of the temperature measurement may be compromised given that the adhesive will start to cool while undergoing the temperature measurement.

Accordingly, there is a need for a more accurate and reliable system of measuring the temperature of heat activated materials or components, such as thermoplastic or thermo-set plastic adhesives, and, preferably, a system that would reduce the occurrence of operator error.

### SUMMARY OF THE INVENTION

Accordingly, the in-process verification system and method of the present invention provides a simple and accurate way to measure the temperature of a material, such as an adhesive, in a non-invasive manner and, further, in a manner to minimize error.

In one form of the invention, an in-process verification system includes a base and a support. The base includes a holding location for holding and locating a sample of a material. The system further includes an infrared sensing system that includes a sensor supported by the support above the base in spaced vertical registry with the base and aligned over the holding location, which measures the infrared radiation emitted by the material and calculates the temperature of the material based on the emitted infrared radiation.

In one aspect, the infrared sensing system further includes a control system, which is in communication with the sensor. The infrared sensor generates a sensor signal indicative of the infrared radiation emitted by the material, with the control system converting the sensor signal into a temperature reading.

In further aspects, the infrared sensing system further includes a display that is in communication with the control system. The display displays at least one temperature reading of the material.

In yet other aspects, the infrared sensing system further includes at least one user interface that is in communication with and provides input to the control system. For example, the user interface device may comprise a control panel. Preferably, the system also includes an interface connector in communication with the control system for coupling the control system with a remote device, such as a data logger, a data accumulation system or the like.

According to other aspects, the system further includes a carrier for supporting the material at the holding location. For example, the carrier may comprise a card, and the card may include a designated location for depositing the material on the card, with the designated location being located in horizontal and vertical registry with respect to the sensor head when the card is positioned at the holding location.

In yet another aspect, the base includes a plurality of projecting pins, which define the perimeter of the holding location.

Accordingly, the present invention provides a non-contact or non-invasive temperature verification system that substantially reduces the occurrences of error.

These and other objects, advantages, purposes, and features of the invention will become more apparent from the study of the following description taken in conjunction with the drawings.

### DETAILED DESCRIPTION OF THE DRAWINGS

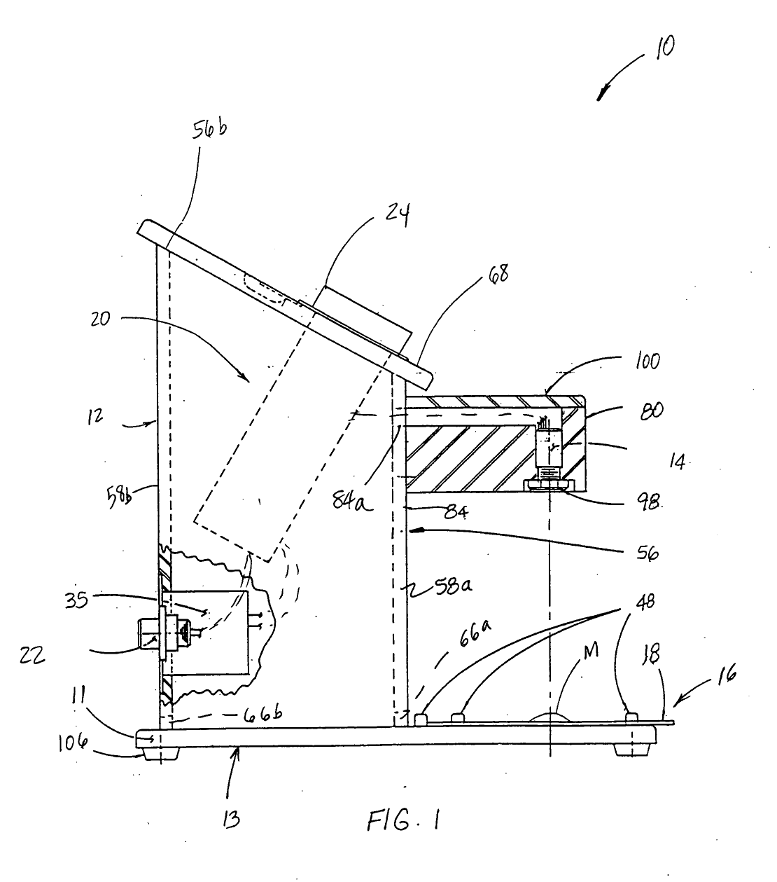

FIG. 1 is a side elevation view of the in-process verification system apparatus of the present invention;

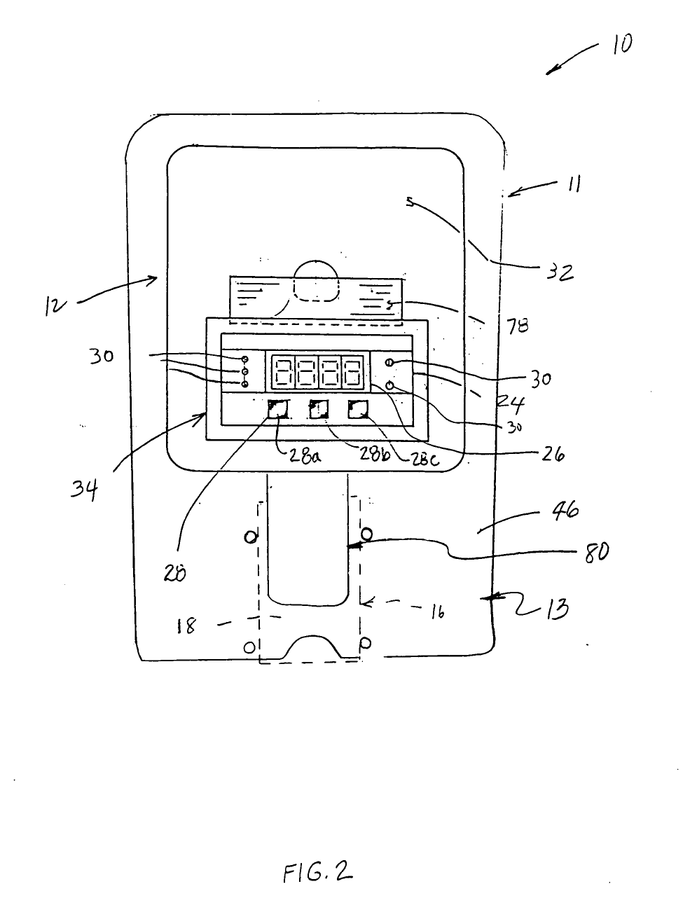

FIG. 2 is a top plan view of the apparatus of FIG. 1;

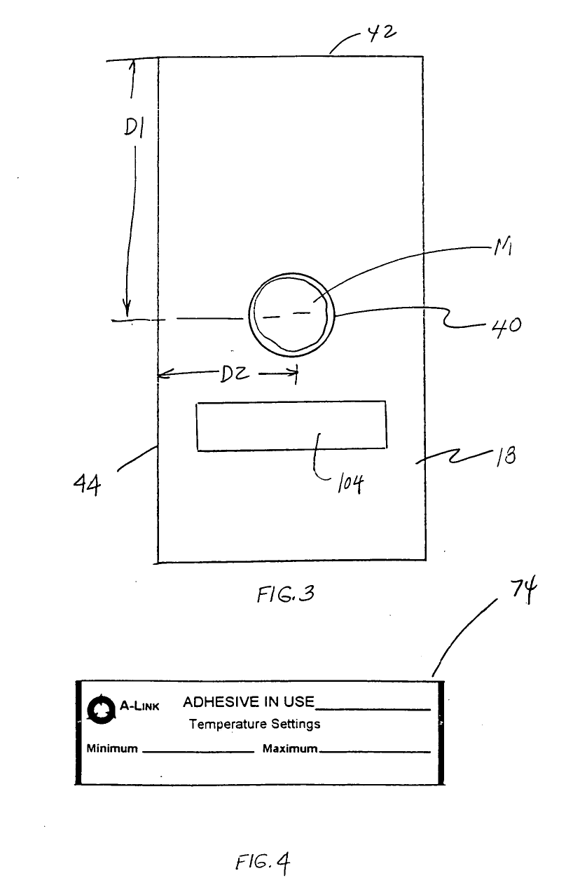

FIG. 3 is a plan view of a carrier that can be used in the apparatus of the present invention;

FIG. 4 is a label that can be used in combination with the apparatus of the present invention;

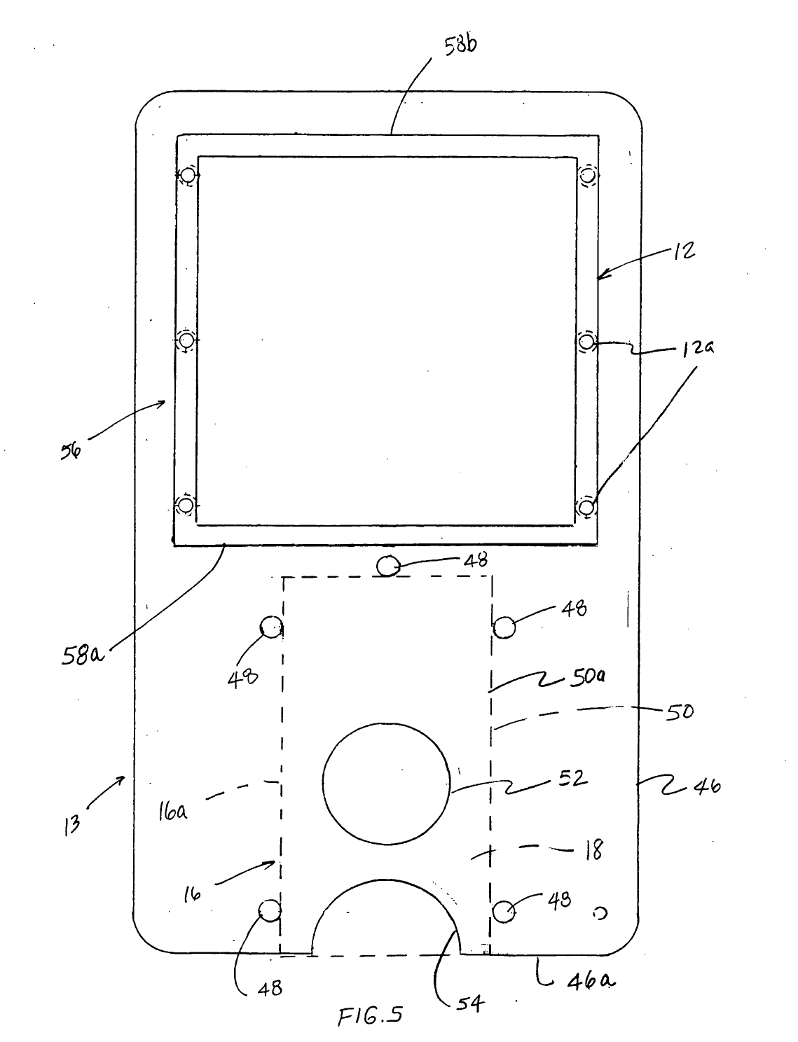

FIG. 5 is an enlarged plan view of the base of the apparatus of FIG. 1;

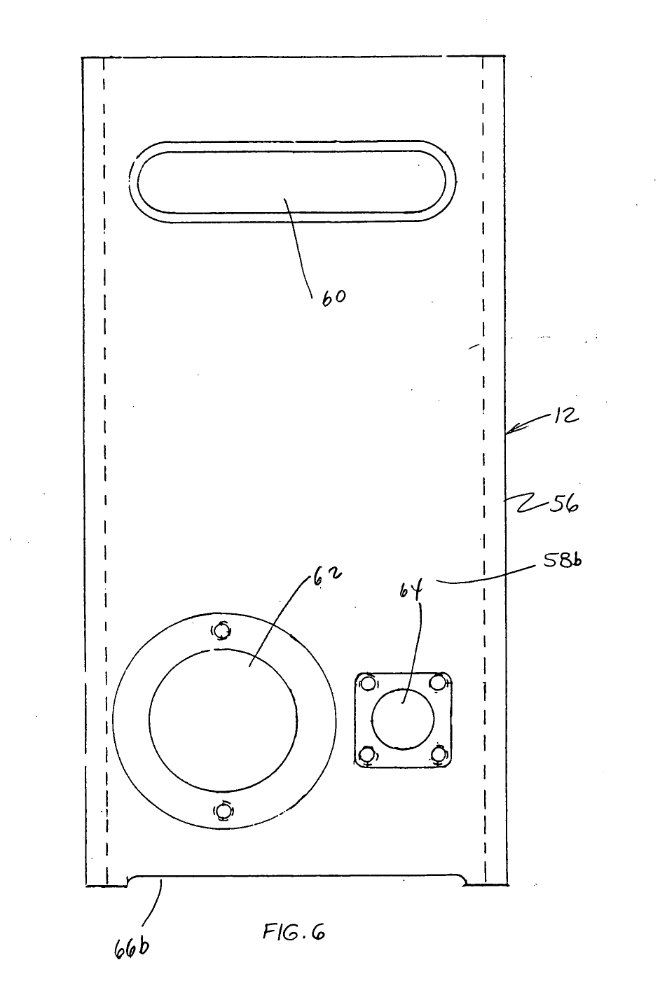

FIG. 6 is a rear elevation view of the sensor support of the apparatus of FIG. 1;

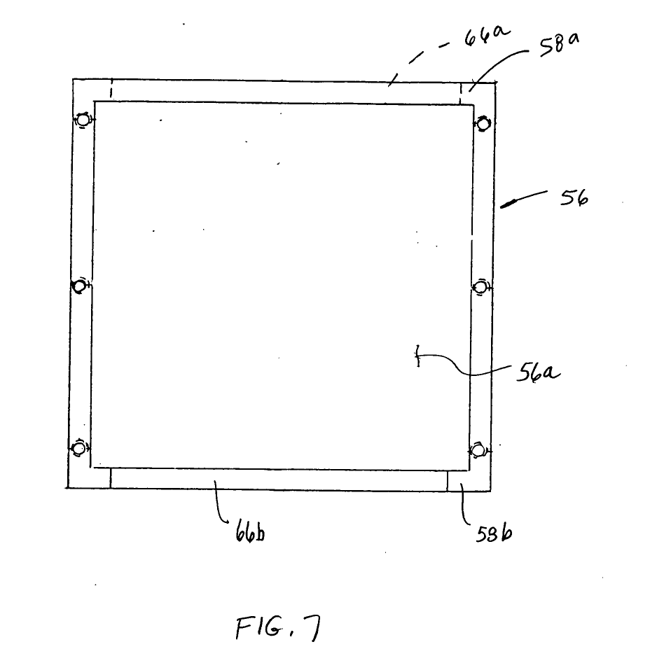

FIG. 7 is a bottom plan view of the sensor support of FIG. 6;

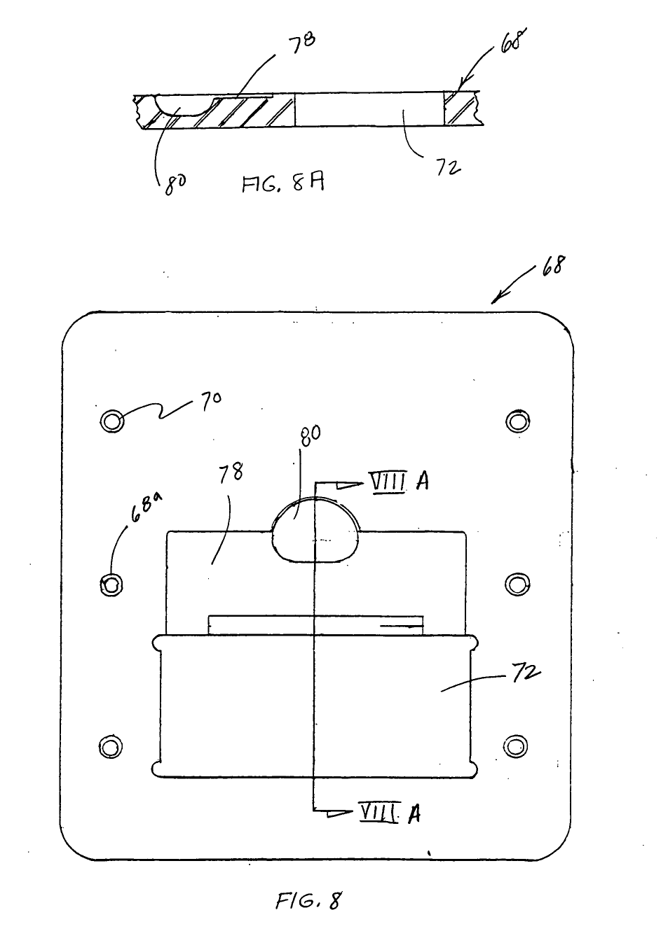

FIG. 8 is a plan view of a top plate of the sensor support of FIG. 1, with the panel removed for clarity;

FIG. 8A is a cross-section view taken along line VIIIA-VIIIA of FIG. 8;

FIG. 9 is a top plan view of the sensor mount of FIG. 1 with the cover removed;

FIG. 10 is a cross-section view taken along line X-X of FIG. 9;

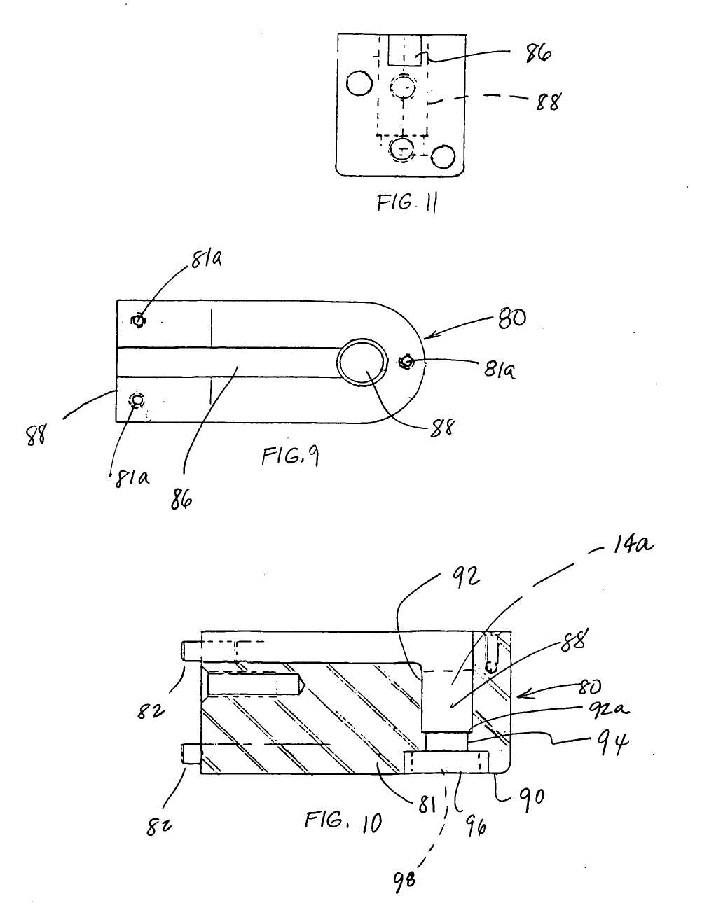

FIG. 11 is an end view of the sensor mount of FIG. 9;

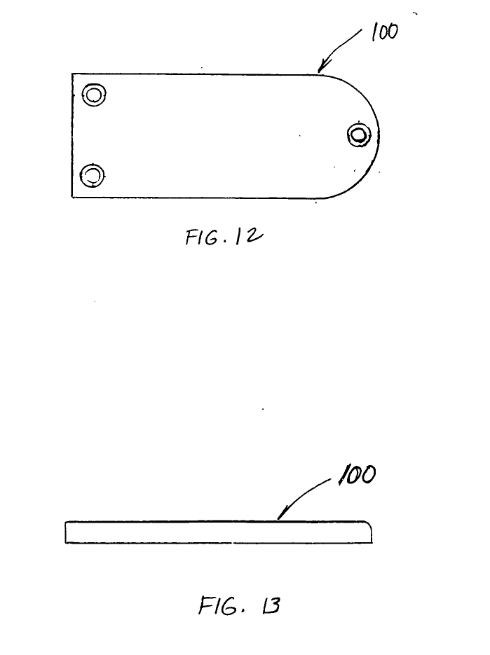

FIG. 12 is a top plan view of a sensor mount cover of the sensor mount of FIG. 9; and

FIG. 13 is a side elevation view of the sensor mount cover of FIG. 9.

### DETAILED DESCRIPTION OF THE PREFERRED EMBODIMENTS

Referring to FIGS. 1 and 2, the numeral 10 generally designates an in-process verification system of the present invention. System 10 is particularly suitable for verifying the temperature of a component or material, such as an adhesive. As will be more fully described below, in-process verification system 10 determines the infrared radiation emitted by the component or material to be verified in order to determine the temperature of the component or material. For illustrative purposes only, reference hereinafter will be made to the determination of the temperature of a material M, such as a heat-activated adhesive, that is placed on a carrier (18).

Referring again to FIGS. 1 and 2, the in-process verification system 10 includes an apparatus 11 and a control system 20 that is discussed in more detail below. Apparatus 11 includes a sensor support 12 and a base 13. Support 12 and base 13 are both preferably fabricated from a rigid material, such as metal, and, more preferably, from aluminum to provide a relatively light, but rigid apparatus. In addition, base 13 may include feet, such as rubber feet 106, to provide greater stability for apparatus 11 and, in turn, system 10.

Support 12 supports a sensor head 14 (of control system 20) in fixed vertical spaced registry with respect to base 13 and, further, in fixed horizontal alignment with a holding location 16 provided or formed on base 13 for measuring the infrared radiation emitted by a material supported in the holding location in order to determine the temperature of material M. As noted above and more fully described below, system 10 is particularly suitable for determining the temperature of a heat-activated material, such as a heat-activated adhesive. In preferred form, system 10 also provides traceability or a record of a material and the temperature of the material as it is dispensed. For example, in the illustrated embodiment system 10 incorporates a card on which information about the material is recorded and, further, on which the material is deposited to thereby act as the carrier (18).

In addition to providing a means for recording the material, carrier 18 locates the deposited material both vertically and horizontally with respect to sensor head 14 so that sensor head 14 is aligned over material M to more accurately read the infrared radiation emitted by the material M. In addition, carrier 18 includes a deposit area 40 (FIG. 3) that is sized to be at least the same size as the sensing area of sensor head 14 at the spacing provided by apparatus 11, as will be more fully described below and, more preferably, that is larger than the sensing area of sensor head 14.

Sensor head 14 comprises an infrared sensor that detects the infrared radiation emitted by material M. The temperature of material M is then determined based on the emitted radiation by and the emissivity of the material, which is either preprogrammed into control system 20 or input by the user. Furthermore, sensor head 14 is spaced from base 13 a distance such that the surface measured by sensor head 14 is less than or equal to the deposit surface area of the material to ensure that preferably none of the surrounding area is being averaged into the surface temperature calculation. In addition, control system 20 calculates the average temperature across the material (that corresponds to the sensing area of sensor head) and preferably displays the temperature for a period of time, for example for a few seconds, and then goes back or takes another reading which is also then displayed for a hold time.

Sensor head 14 is coupled to and in communication with control system 20 (shown generally in FIG. 1), which receives a sensor signal from sensor head 14, which is proportional to the emitted infrared radiation from the material, and then calculates the temperature based on the signal generated by sensor head 14. In this calculation, control system 20 factors in the emissivity of the material as well as calibration factors for the sensor head. As noted above, system 10 may use the emissivity value preprogrammed into control system 20 or may use an emissivity value input by the user. The calibration factors are typically determined by the sensor head manufacture.

Control system 20 is preferably housed in support 12 and, further, may be coupled (or in communication) to an interface connector 22 for coupling control system 20 to an external and/or remote device, such as a data logger, a chart recorder, a standard data accumulation system, or, for example, into a production management system to which the data collected by control system 20 may be downloaded or accessed. Connector 22, for example, may comprise a 4-20 mili amp port, which is preferably located on the rear of support 12.

Control system 20 includes a control panel 24 and preferably includes one or more displays 26 and one or more user actuatable devices 28 (FIG. 2). For example, displays 26 may comprise liquid crystal displays. User actuatable devices 28 may comprise buttons, such as snap-action memory-type push button switches, for example, or the like. In addition, control panel 24 preferably includes one or more indicators 30, such as a low battery indicator and an on/off indicator or the like. User actuatable devices 28 permit the operator to input data into system 10. For example, input data may include the min/max heat application temperatures of the material, read-out accuracies, the emissivity of the material, sensor head parameters (e.g. calibration factors), sensor identification, dwell times or hold times, programmable temperature windows, for example, for the output, Fahrenheit or Celsius selection, ambient temperature compensation or the like. Panel 24 is preferably mounted to an upper plate 32 of support 12 and may, for example, be mounted by a bezel 34. In the illustrated embodiment, upper plate 32 is angled relative to base 13 for ease of reference.

In the preferred embodiment, control system 20 includes a microprocessor and one or more memory devices associated with the microprocessor. Operation of the microprocessor is preferably controlled by a program stored in one of the memory devices and, further, by one or more user actuatable devices 28 on panel 24. As noted above, apparatus 11 may be powered by batteries or may be powered by a 110-volt power supply through a power supply plug 35. The signals from sensor head 14 are communicated to the microprocessor through an analog-to-digital converter with the data output from the microprocessor delivered to the display by a display driver circuit. Suitable sensors and sensor control systems are available from RAYTEK of California, EXERGEN of Massachusetts, LAND of Pennsylvania, and IRCON of Illinois.

As noted above, sensor head 14 measures the emitted infrared energy of material M; however, in order to correctly calculate the temperature, the emissivity value of the material being verified must be determined and compared to the default emissivity value (if control system 20 includes a default value). If the emissivity value is different than the default value, then the actual emissivity value must be input into control system 20 to ensure accuracy of the temperature measurement. Emissivity is a measure of the thermal emittance of a surface—and the emissivity value is defined as the fraction of energy that is emitted as compared to the amount of energy emitted by a black body. A black body is a material that is a perfect emitter of heat energy and emits all energy it absorbs. The emissivity value of a black body is set as 1 (or 100%). For example, a perfect reflector or mirror would have an emissivity value of zero. According to Plank's law, the energy emitted off a given surface is related to the temperature of the surface to the fourth power. The proportionality constant consists of the product of the Stephen-Boltzmann constant and the surface emissivity. In non-contact methods, therefore, the surface emissivity may be used when determining the temperature of the surface. Optionally, as noted control system 20 includes a preset or default emissivity value, but preferably includes an adjustable emissivity value that can be adjusted by, for example, user actuatable devices 28 as noted above.

Referring to FIGS. 2 and 3, material M is deposited on carrier 18 at deposit location 40, which is located at a fixed horizontal distance D1 from the back edge 42 of carrier 18 and at a fixed horizontal distance D2 from the side edge 44 of carrier 18. Carrier 18 is then placed at a holding location 16 on base 13, which is fixed in horizontal registry and, further, in fixed vertical registry with respect to sensor head 14. As best seen in FIG. 5, base 13 comprises a generally rectangular plate 46. Mounted to plate 46 are a plurality of locator pins 48 that define therebetween holding location 16. In addition, plate 46 includes an opening 52 that is located within a perimeter 16a of holding location 16 and which acts as an insulator to minimize a potential conduction of heat from the material to base 13. Similarly, plate 46 may include a notch 54 at its edge 46a to facilitate the gripping and removal of carrier 18 from holding location 16.

As best understood from FIG. 5, support 12 is mounted to base 13 by a plurality of fasteners 12a. Suitable fasteners may include bolts, screws, dowels, or the like. Alternately, support 12 may be permanently fixedly mounted to base 13 by welding. As best understood from FIGS. 1, 5, and 6, support 12 includes a vertical tubular member 56. In the illustrated embodiment, tubular member 56 has a generally square cross-section and, as noted previously, is mounted to base 13 by a plurality of fasteners. Preferably, tubular member 56 is securely fastened to base 13 to provide a rigid stable support for sensor mount 80 and sensor head 14. To provide access to control system 20, back wall 58 of tubular member 56 includes a plurality of ports 60, 62, and 64 (FIG. 6). Port 62 provides a port for the power supply plug 35, while port 64 provides a port for interface connector 22. Port 60 provides a vent to permit air circulation through the cavity 56a of tubular member 56 to avoid heating up of the various components that comprise control system 20 and also may form a handle for carrying apparatus 11. Similarly, referring to FIGS. 6 and 7, front and back walls 58a and 58b may include one or more coped sections 66a and 66b at their lower ends to further facilitate the circulation of air through tubular member 56.

Referring again to FIG. 1, tubular member 56 is cut at an angle or is formed to provide an angled support surface 56b for mounting a cover or mounting plate 68 to tubular member 56, which as noted above provides a mounting surface for panel 24. Referring to FIG. 8, cover plate 68 similarly comprises a generally rectangular plate and includes a plurality of mounting openings 70 and an access opening 72. Cover plate 68 is mounted to tubular member 56 by a plurality of fasteners 68a, such as bolts, screws, dowels, or the like, through mounting openings 70. Positioned through opening 72 is panel 24, which is secured to cover plate 68 by mounting brackets seated to the underside of cover plate 68. Components of panel 24 are then connected to or in communication with control system 20 by, for example wiring, cabling, or the like that are contained in tubular member 56. Optionally and preferably, as illustrated control panel 24 and control system 20 may comprise a single modular unit that may be placed in tubular member 56 through opening 72 and secured therein by the mounting brackets. Alternately, control system 20 may be mounted in tubular member 56 separate and apart from panel 24, with control system 20 communicating with the components on panel 24 via cables or wiring or the like.

Referring to FIG. 4, when using in-process verification system 10, it may be preferable to provide an information card 74, or the like, that provides the operator with a convenient display of pertinent input information. For example, the information may include an identification of the material being tested and the high and low temperatures for pre-programming into control system 20, which establishes an acceptable range for the material being processed. To provide a convenient location for the information card, plate 68 may be provided with a recessed area 78 so that the information card may be placed above the panel 24 and nested in the plate. To ease removal of the card from recess 78, plate 68 may further include a second recess 80 that extends further or deeper into plate 68 to ease or facilitate the gripping and removal of information card 74 from recess 78.

As previously noted, in-process verification system 10 includes a sensor head 14 that is in vertical spaced registry with respect to base 13 and, further, which is horizontally located with respect to and aligned with the holding location and, more specifically, with the designated deposit location on card 18. Referring to FIGS. 1 and 10, support 12 also includes a sensor head mount 80. Sensor head 14 is supported by support 12 in sensor head mount 80, which is mounted to tubular member 56 by fasteners 82, such as dowels, bolts, screws, or the like, that extend into mounting openings provided on the front wall 58a of tubular member 56. Sensor mount 80 comprises a block-shaped body 81 with a transverse horizontal passage 86 extending from its mounting end 88 to a vertical passageway 88 that extends from lower side 90 of body 81 to upper side of body 81. Vertical passage 88 has a generally cylindrical cross-section with an upper cylindrical portion 92, a medial cylindrical portion 94, and a lower cylindrical portion 96. Medial cylindrical portion 94 has a smaller diameter than upper cylindrical portion 92 and lower cylindrical portion 96. Sensor head 14 is positioned in portion 92 and is seated on annular seat 92a formed by the transition between cylindrical portion 92 and cylindrical portion 94. Sensor head 14 is retained in cylindrical portion 92 by a sensing head retention nut 98, such as a hex nut, that threads onto the sensor head housing 14a and secures sensor head 14 in sensor head mount. Sensing head 14 is coupled to control system 20 by a wiring and/or cables that extend from passageway 88 through passageway 86 and then through an opening 84a provided in front wall 58a of tubular member 56.

In order to close passageways 86 and 88, sensor mount 80 includes a cover 100 (FIGS. 12 and 13), which is secured to body 81 by a plurality of fasteners, such as bolts, screws, dowels, or the like, that extend into mounting openings 81 a formed or otherwise provided in body 81. In this manner, the connecting wires or cables and, further, the sensor head are protected from debris but are otherwise accessible when cover 100 is removed.

To set up system 10, the operator optionally and preferably provides information relating to the test on the back of the carrier: For example, the operator's employee number, the date and time, location, and the production number and the lot number of the material. Furthermore, additional information relating to the temperature settings, machine settings, the tank identification, the gun identification, the hose identification, and actual temperature readings may be provided so that a record of the process parameters be recorded on the carrier as well as a sample of the material. In this manner, this deposit of material may be used for later testing. For example, the deposit material may be used to confirm a “clean date”—to provide an ability to track back in a production setting that parts made after a certain date are acceptable. The operator then places the information card 74, which has been similarly filled out with minimum/maximum temperatures and the emissivity value of the material, in recessed areas 78 for ease of reference, with the information card providing the min/max temperature data for control system 20 via user actuatable devices 28 provide in panel 24. Similarly, the default emissivity value is then checked and adjusted as needed.

In operation, after control system 20 has been programmed with the various input data, carrier 18 is placed in holding location 16 between pins 48 and a sample of the material, such as a molted adhesive, is applied to the designated deposit area 40 on carrier 18 so that the material is aligned in a fixed, preselected location under sensing head 14. In this manner, material M is located vertically at a fixed vertical distance from sensor head 14 and, further, is aligned at a preselected distance under sensor head 14 such that the surface area of material M is at least equal to the area measured by sensor head 14 and, more preferably, exceeds the area measured by sensor head 14. In this manner, when operational, the sensor head senses the emitted radiation from a preselected, confined surface area of the material.

After the material has been deposited, the operator then initiates the process. As previously noted, panel 24 may include a plurality of displays 26 and a plurality of indicator or indicator lights 30 and, further, a plurality of user actuatable devices 28. In the illustrated embodiment, panel 24 includes four (4) light emitting diode (LED) displays, three (3) user actuatable keys or pads, and five (5) indicating lights. One of the keys, such as key 28a, may comprise an information key, with other keys, such as keys 28b, 28c, comprising direction keys, which are used in combination with the information key to select the different functions, with displays 26 preferably indicating the function being addressed by the selected function. Optionally, control system 20 may incorporate an alarm either an audible alarm or a visual alarm, such as a visual indicator (such as one of the visual indicators 30) to indicate if the temperature is below the minimum specified temperature or above the maximum specified temperature. A second indicator light may provide an indication when the measured temperature exceeds the maximum temperature set point, which is input by the operator. A third indicator light may be used to indicate when the measured temperature is within the preset maximum and minimum temperature limit set points. Optionally and preferably, indicator lights also provide an indication of whether the measurements are in degrees Celsius or degrees Fahrenheit.

As previously noted, system 10 may be powered by batteries. However, in the illustrated embodiment, system 10 is powered by a standard 110/120 volt outlet. When plugged in to the outlet, the initial reading display will be the ambient or room temperature. When the ambient temperature is displayed, the information key 28a may be pressed to confirm that the emissivity value is set at a default value, such as 0.95. When measuring the temperature of a hot melt adhesive, for example, the default value should be adequate. If the emissivity value does not correspond to the default value, the value may be adjusted by the increase or decrease buttons 28b or 28c. As previously noted, emissivity is a measure of an object's ability to absorb, transmit, and emit infrared energy. Therefore, if the emissivity value of the material being verified is not properly entered into the system, the temperature calculations will not be accurate.

Once the emissivity value is confirmed to be the correct emissivity value, then the information button may be pressed to set the minimum or low temperature setting or set point (S1) and the maximum or high temperature set point S2. Therefore, for example, when displays 26 indicates S1, the information button should be pushed followed by the increase or decrease buttons 28b or 28c to set the low temperature limit. The information button then should be pressed again to confirm that the temperature has now been set for the low temperature limit. Once this is confirmed, the information button is pressed again to display S2, followed by the information button being pressed for the second time in combination with the up or down buttons to set the high temperature limit. After the settings are complete for system 10, and the pertinent information is filled in on the back side of the carrier or card, then, as noted above, carrier 18 is placed on base 13 between the locating pins and against the back locating pin in holding location 16; thereafter, the material is then deposited on the card preferably entirely covering the designated deposit area. When activated, system 10 will then average the temperature of the adhesive (for example, in approximately one second) and display and hold that reading for a preprogrammed hold time before taking another reading and repeating the process. At this point, the operator must watch the three indicators to check whether the temperature is below the minimum set point, above the maximum set point, or within the set points. Once the temperature has been calculated and displayed, the card should be removed with the actual temperature recorded on the card. As previously noted, these carriers may be used to record the temperature of the material as well as store/record a sample of the material for later testing should there be a question regarding the assembly.

Accordingly, the in-process verification system of the present invention provides a free standing apparatus that allows for easy deposition of small quantities of material, such as a molten thermoplastic adhesive, onto a stable carrier, such as carrier 18. Carrier 18 is preferably a low moisture emissivity stable record card that may be used to support the material during testing and, further, may be used as a record card for traceability. Because the location of the sensor head relative to the target material to be measured is fixed in both a vertical and horizontal direction, repeatable and accurate measurements may be achieved. Furthermore, the connector port allows for monitoring, recording, or downloading of the recorded data via an external source.

While one form of the invention has been shown and described, other modifications and changes will be appreciated by those skilled in the art. For example, holding location 16 may be defined by a plurality of elongate ribs, discrete ribs, a continuous U-shaped rib, or by a recessed portion of plate 46. In addition, while the various components forming the base and the sensor support are illustrated in rectangular configurations, the shape of any one of these components can be varied. Furthermore, while described n reference to a system that is suitable for manual placement of the carrier in or on apparatus 10, it is also contemplated that apparatus 10 may used in conjunction with a robotic application. In addition, apparatus 10 may incorporate a shuttle or carriage that is driven between a loading position and a loaded position where the carrier is positioned for verification. Therefore, it will be understood that the embodiments shown in the drawings and described above are merely for illustrative purposes only, and are not intended to limit the scope of the invention that is defined by the claims that follow as interpreted under the principles of patent law including the doctrine of equivalents.

We claim:

1. An in-process verification system comprising:
a base, said base having a holding location for holding and locating a sample of a material;
a support; and
an infrared sensing system, said infrared sensing system including a sensor supported by said support above said base in spaced vertical registry with said base and aligned over said holding location for detecting infrared radiation emitted by the material, said infrared sensing system calculating the temperature of the material based on the infrared radiation emitted by the material.

2. The in-process verification system according to claim 1, wherein said infrared sensing system further includes a control system, said control system in communication with said sensor, said sensor generating a sensor signal indicative of the infrared radiation emitted by the material and said control system converting said sensor signal into a temperature reading.

3. The in-process verification system according to claim 2, wherein said infrared sensing system further includes a display, said display in communication with said control system, said display displaying at least one temperature reading of the material.

4. The in-process verification system according to claim 2, wherein said infrared sensing system further includes at least one user interface, said user interface in communication with and providing input to said control system.

5. The in-process verification system according to claim 4, wherein said user interface device comprises a control panel.

6. The in-process verification system according to claim 4, wherein said user interface device comprises at least one touch pad.

7. The in-process verification system according to claim 5, further comprising an interface connector in communication with said control system and for coupling said control system with a remote device.

8. The in-process verification system according to claim 1, further comprising a carrier, said carrier for supporting the material at said holding location.

9. The in-process verification system according to claim 8, wherein said carrier comprises a card.

10. The in-process verification system according to claim 9, wherein said card includes a designated location for depositing the material on said card, said designated location being located in horizontal and vertical registry with respect to said sensor when said card is position at said holding location.

11. The in-process verification system according to claim 8, wherein said base includes a plurality of projecting pins, said pins defining the perimeter of said holding location.

12. An in-process verification system comprising:
a base, said base having a holding location adapted to hold and locate a sample of a material in a fixed location;
a support mounted to and extended from said base; and
an infrared sensing system, said infrared sensing system including a control system and a sensor in communication with said control system, said sensor supported by said support above said base in spaced vertical registry and horizontal registry with said fixed location, said sensor detecting the infrared radiation emitted by the material, said control system calculating the temperature of the material based on the infrared radiation detected by said sensor and an emissivity value either stored in said control system or input into said control system.

13. The in-process verification system according to claim 12, wherein said sensor is coupled to said control system.

14. The in-process verification system according to claim 12, wherein said sensor is spaced from said base a distance such that the surface measured by said sensor is less than or equal to a deposit surface area of the material.

15. The in-process verification system according to claim 12, wherein said sensor generates a sensor signal proportional to the infrared radiation emitted by the material, said control system receiving said sensor signal and calculating the temperature from said sensor signal and said emissivity value.

16. The in-process verification system according to claim 12, wherein said infrared sensing system further includes a display, said display in communication with said control system, said display displaying at least one temperature reading of the material based on said temperature calculated by said control system.

17. The in-process verification system according to claim 16, wherein said control system includes a control panel, said control panel including said display.

18. The in-process verification system according to claim 16, wherein said control panel includes at least one user actuatable device for inputting data into the control system.

19. The in-process verification system according to claim 17, wherein said control panel is mounted to said support.

20. The in-process verification system according to claim 19, further comprising an interface connector in communication with said control system for coupling said control system with a remote device.

21. The in-process verification system according to claim 12, further comprising a carrier, said carrier having a fixed deposit location for the material, said carrier placed at said fixed location of said base to thereby locate the material in vertical registry and horizontal registry with said sensor to calculate the temperature of the material.

22. The in-process verification system according to claim 21, wherein said fixed deposit location includes a deposit surface area, said sensor being spaced from said carrier a distance such that the surface measured by said sensor is less than or equal to said deposit surface area.

23. The in-process verification system according to claim 22, wherein said carrier comprises a card.

24. The in-process verification system according to claim 23, wherein said base includes a plurality of projecting pins, said pins defining the perimeter of said holding location and locating said card relative to said sensor when said card is positioned on said base between said pins.

25. A method of verifying a temperature of a material comprising:
supporting an infrared sensor at a preselected location;
positioning a material at a preselected and fixed distance from the sensor;
sensing and measuring the emitted infrared radiation from a predetermined confined surface of the material;
providing an emissivity value for the material; and
calculating the temperature of the material from the measured emitted infrared radiation and the emissivity value.

26. The method according to claim 25, wherein said supporting an infrared sensor includes supporting the sensor on an apparatus, and said positioning includes supporting the material on the apparatus.

27. The method according to claim 26, wherein said positioning includes spacing the material at a distance from the sensor such that the surface sensed and measured by the sensor is less than or equal to the surface area of the material.

28. The method according to claim 25, further comprising providing a minimum temperature and a maximum temperature, and comparing the calculated temperature to said minimum and maximum temperatures.

29. The method according to claim 25, further comprising displaying the calculated temperature.
